(19) United States
(12) Patent Application Publication
(10) Pub. No.: US 2007/0246087 A1
(43) Pub. Date: Oct. 25, 2007

(54) Cartridge-filter cleaning machine

(76) Inventors: Randal W. Crawford, Spring, TX (US); Gregory Allen Shahan, Tomball, TX (US)

Correspondence Address: MARY J. GASKIN;ANNELIN & GASKIN, 2170 BUCKTHORNE PL., SUITE 220, THE WOODLANDS, TX, 77380, US

(21) Appl. No.: 11/408,718

(22) Filed: Apr. 21, 2006

(51) Int. Cl. B08B 3/04; B08B 3/00; B08B 3/12; B08B 9/00

(52) U.S. Cl. 134/104.2; 134/111; 134/110; 134/184; 134/198; 134/166 R

(57) ABSTRACT

A machine for cleaning cartridge filters used in pool filtration systems. The machine has a cleaning chamber which holds an adjustable tail stock assembly with a first cone and a second cone mounted onto a power-driven motor. The cones are pulled apart to accommodate a dirty cartridge filter. One end of the cartridge filter is placed against the second cone, and the first cone, which can be spring-loaded, is pressed against the other end of the cartridge filter. The cartridge filter is then locked in place. The power-driven motor spins the second cone, while heated water is injected into and through the hollow shafts of the tail stock assembly and the first cone, and into the perforated tube of the cartridge filter, where centrifugal force causes the water to leave the tube of the cartridge filter, carrying away dirt deposits on the surface of the cartridge. A row of spray nozzles can be used to rinse the cartridge filter. The used water is filtered, reheated, and recirculated back into the cleaning chamber.

### FIELD OF THE INVENTION

The present invention relates to a machine for effectively cleaning a cartridge filter used to filter water in swimming pools.

### BACKGROUND OF THE INVENTION

Cartridge filters are one type of filter used with swimming pool filtration systems. A cartridge filter is typically cylindrical in shape, with longitudinal pleats made from porous filtering material. The pleats are mounted onto a perforated tube. The dirt and debris removed from the pool by the filtration system collects on the surface of the pleats when water is drawn from the pool through the filtering material of the cartridge filter and into the tube. The filtered water then exits from the top of the cartridge filter and is returned to the pool. As the debris accumulates, the filtration pump must work harder and harder to pull water through the cartridge filter. At some point, the pool owner must try to clean the cartridge filter so that the filtration system can work more efficiently.

Present cleaning methods are questionable at best. Typically, swimming pool maintenance personnel and swimming pool owners try unsuccessfully to completely and thoroughly clean their filter cartridges. Often they will try to hose off the debris using only the low-pressure water delivered from a garden hose. Other inventors have proposed devices for spinning a filter cartridge while spraying its outer surface. However, the proposed devices are messy and not particularly effective. In reality, simply spraying the outside of the cartridge filter can lodge dirt more firmly in the filtering material instead of removing it. Further, a garden hose cannot be used to effectively clean the inside of a cartridge filter. When a cartridge filter cannot be satisfactorily cleaned, a pool owner will prematurely replace his pool's dirty cartridge filters with new ones, at great cost, and will discard the used cartridge filters in a landfill.

Clearly, there is a need for a machine and process for effectively and efficiently cleaning cartridge filters so that a pool owner can continue to use them with his pool filtration system.

### SUMMARY OF THE INVENTION

The present invention provides a machine for cleaning cartridge filters used in pool filtration systems. The machine is a self-contained, stainless steel unit, with a cleaning chamber for spinning and power-washing a dirty cartridge filter. The user begins by sliding back an adjustable tail stock assembly and aligning a dirty cartridge filter between two opposing cones, which are made from dense polyethylene plastic. The first cone, which is attached to the tail stock assembly, can be spring-loaded so that it can be pulled back, then released, with its tip pressed against a first end of the cartridge filter, providing spring tension to help hold it in place. The components of the tail stock assembly and the first cone have hollow cores. The second cone, against which the second end of the cartridge filter is placed, has a shaft which is mounted on a power-driven motor; the activated motor spins the shaft at a high rate of speed, thereby imparting rotation to the cartridge filter. The water-resistant ball bearings of the tail stock assembly allow rotation of the first cone as well. As the cartridge filter is spinning, heated water is injected through the hollow components mounted on the tail stock assembly and through the first cone into the perforated tube of the cartridge filter. The centrifugal force created by the rotation causes the water to leave the tube of the cartridge filter through the filtering material, carrying with it the deposits on the surface of the cartridge filter. A row of spray nozzles also receives heated water, which is sprayed on the spinning cartridge filter to help remove the loosened dirt and debris. The used water is filtered and collected in reservoirs under the cleaning chamber, where it is reheated and recirculated back into the cleaning chamber as part of the cleaning process.

It is an object of the present invention to provide a machine for cleaning cartridge filters efficiently and effectively, in a controlled manner.

Another object of the present invention is to restore a cartridge filter to its best possible condition so that its continued use with a pool water filtration system does not strain the system or diminish its effectiveness and efficiency.

Yet another object of the present invention is to increase the life expectancy of cartridge filters so they don't have to be replaced as often.

A further object of the present invention is to increase the life expectancy of pool water filtration systems by providing a cost-effective machine that encourages pool owners to have their cartridges filters cleaned on a regular basis.

Other advantages of the present invention will become obvious upon review of the description of the preferred embodiment, infra.

### BRIEF DESCRIPTION OF THE DRAWINGS

FIG. 1 is a perspective view of the top and front of the cartridge-filter cleaning machine of the present invention.

FIG. 2 is a top plan view of the cartridge-filter cleaning machine of the present invention, before a cartridge filter is installed for cleaning.

FIG. 3 is a cross-sectional detail drawing of the spring-loaded water-inlet cone, which is mounted on the tail stock assembly of the cartridge-filter cleaning machine of the present invention.

FIG. 4 is a partially cutaway plan view of the front of the cartridge-filter cleaning machine of the present invention, showing the process and mechanisms used in cleaning a cartridge filter.

FIGS. 5A through 5F are top plan views showing the steps involved in installing, cleaning, and drying a cartridge filter, using the cartridge-filter cleaning machine of the present invention.

FIG. 6 is a block diagram showing the flow of water through the system when it is used to clean a cartridge filter.

### DESCRIPTION OF THE PREFERRED EMBODIMENT

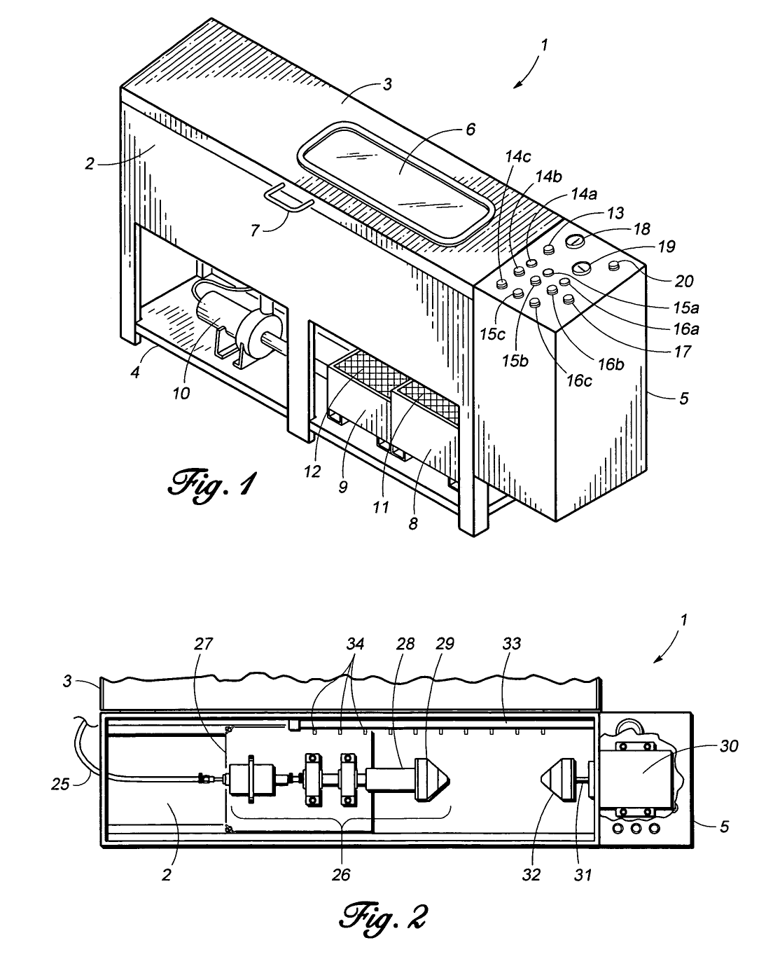

As shown in FIG. 1, the box-shaped cartridge-filter cleaning machine 1 of the present invention has a cleaning chamber 2, a lid 3, a support shelf 4, and a control panel console 5. Power and water are supplied to the cartridge-filter cleaning machine 1 by conventional means. The lid 3 has a wire safety glass window 6, which allows the user to view the cycles of the cleaning process. The handle 7 is used to open and close the lid 3. The support shelf 4 supports a primary reservoir 8, a secondary reservoir 9, and a water pump 10. Each reservoir 8, 9 is covered with mesh screen 11, 12, which traps dirt and debris from the cleaning operation. Atop the control panel console 5 is an array of switches and gauges. Main power supply switch 13 controls power to the cartridge-filter cleaning machine 1. Power supplied to the cartridge-filter cleaning machine 1 can be generated by electricity or by use of a combustible fuel, such as gasoline, propane, etc. Water pump activation button 14a turns on the water pump 10; green indicator light 14b illuminates when the water pump 10 is running; and water pump deactivation button 14c turns it off. Similarly, the power-driven motor (discussed infra) is activated by motor “on” switch 15a; green indicator light 15b illuminates when the power-driven motor is running; and power-driven motor “off” switch 15c turns it off. “On” switch 16a energizes the contactors for the water heating elements (not shown) in reservoirs 8, 9 and for the thermostat; green indicator light 16b illuminates when the water heating elements are energized; and off” switch 16c de-energizes the water heating elements. A variable speed regulator 17 allows the user to control the revolutions per minute (RPM's) of the power-driven motor. Water pressure output sensing gauge 18 provides information related to the water pressure in the system, while water temperature sensing gauge 19 lets the user keep the temperature of the water at a safe and effective level. Emergency stop switch 20 is wired to the main service power disconnect. When it is manually activated, none of the other components of the cartridge-filter cleaning machine 1 will operate until it is manually reset.

FIG. 2 looks down on the cleaning chamber 2 of the cartridge-filter cleaning machine 1, with the lid 3 open, showing the mechanisms for holding, spinning, and washing a cartridge filter. An adjustable tail stock assembly 26 has been mounted on plate 27, which moves in a track guide. The plate 27 can be slid back or forth, depending on the length of the cartridge filter being cleaned. A flexible water supply line 25 introduces heated water into the hollow components of the tail stock assembly 26. The water will travel through the hollow core of the shaft 28 and out the end of the spring-loaded water inlet cone 29. On the right side of the figure is a conventional power-driven motor 30, which is mounted inside the control panel console 5. It rotates the shaft 31 of the drive motor cone 32, causing it to spin. Both the water inlet cone 29 and the drive motor cone 32 are made from milled, dense polyethylene plastic. A finishing rinse supply pipe 33, typically made of stainless steel, delivers heated water to brass spray nozzles 34.

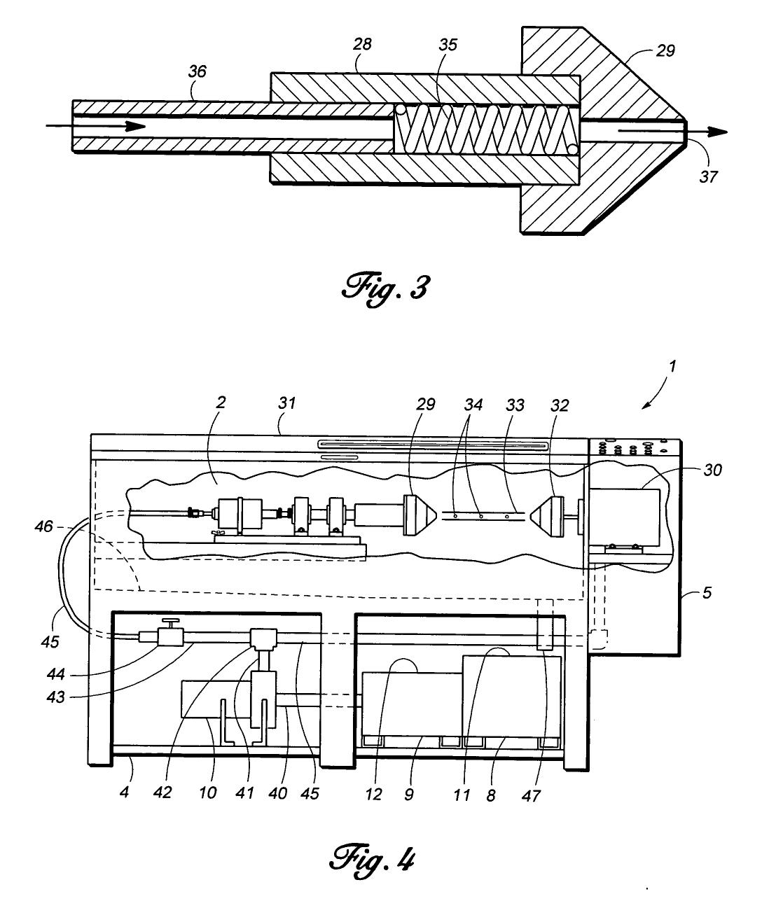

FIG. 3 is a detail drawing of the spring-loaded water inlet cone 29. A stainless steel spring 36 is disposed inside the hollow core of the shaft 28, where it is held in place by the end of the shaft 35 mounted on the tail stock assembly 26. The spring 36 is compressed when the water inlet cone 29 is pushed back towards the tail stock assembly 26. In operation, water travels through the hollow cores of the shafts 36, 28, and out through the tip 37 of the water inlet cone 29.

FIG. 4 shows a partially cut-away view of the cartridge-filter cleaning machine 1, with the lid 3 closed. The cleaning chamber 2 has a support shelf 4 for the primary reservoir 8 and the secondary reservoir 9. Additives such as degreasers and sanitizers can be added to the reservoirs 8, 9 to remove foreign matter such as suntan lotion and oils from the water. Each of the reservoirs 8, 9 has a heating element (not shown), such as the type used with electric water heaters (for instance, an electrical heater using 220 volts AC power). Both of the heating elements are controlled by a thermostat, allowing the set point of the water's temperature to be manipulated. Typically, the thermostat setting will be kept at or slightly below the thermostat's maximum temperature of 160° F. At that temperature, contaminants such as suntan lotions and oils are displaced, yet the glue bands that hold a cartridge filter together are not damaged.

In operation, the primary reservoir 8 is filled with water, which is heated. The water flows from the primary reservoir 8 into the secondary reservoir 9, which also heats the water. Suction pipe 40 pulls the heated water from the secondary reservoir 9 into the water pump 10, which is driven by a motor (for instance, an electric motor using 220 volts AC power). The centrifugal-type water pump 10 uses an impeller, which turns at a high rate of speed, then “slings” water around the inside of the housing. The water is pumped from the water pump 10 through PVC (polyvinyl chloride) piping 41, to PVC tee-pipe 42, which directs a supply of water though PVC pipe 43 to water pump isolation valve 44, on to the flexible water supply line 25, and out through the water inlet cone 29. Water is also directed through PVC pipe 45 to the finishing rinse supply pipe 33 and out through the spray nozzles 34. The pressure of the water traveling through PVC pipe 45 can be read by water pressure output sensing gauge 18. The water pump isolation valve 44 can be used to adjust the amount of water flowing to the water inlet cone 28 and to the spray nozzles 34. The drive motor cone 32 is rotated by activating the power-driven motor 30 inside the control panel console 5. The water which sprays out of the water inlet cone 29 and the spray nozzles 34 collects on the slightly sloped bottom 46 of the cleaning chamber 2 of the cartridge-filter cleaning machine 1, then pours through water return pipe 47, back into the primary reservoir 8, where it is reheated and recirculated through the system. Debris and dirt from the cleaning operation are collected on top of mesh screens 11, 12. Optionally, the water from the water return pipe 47 can be cycled through a sand-filter system (not shown) to remove debris and dirt from the water.

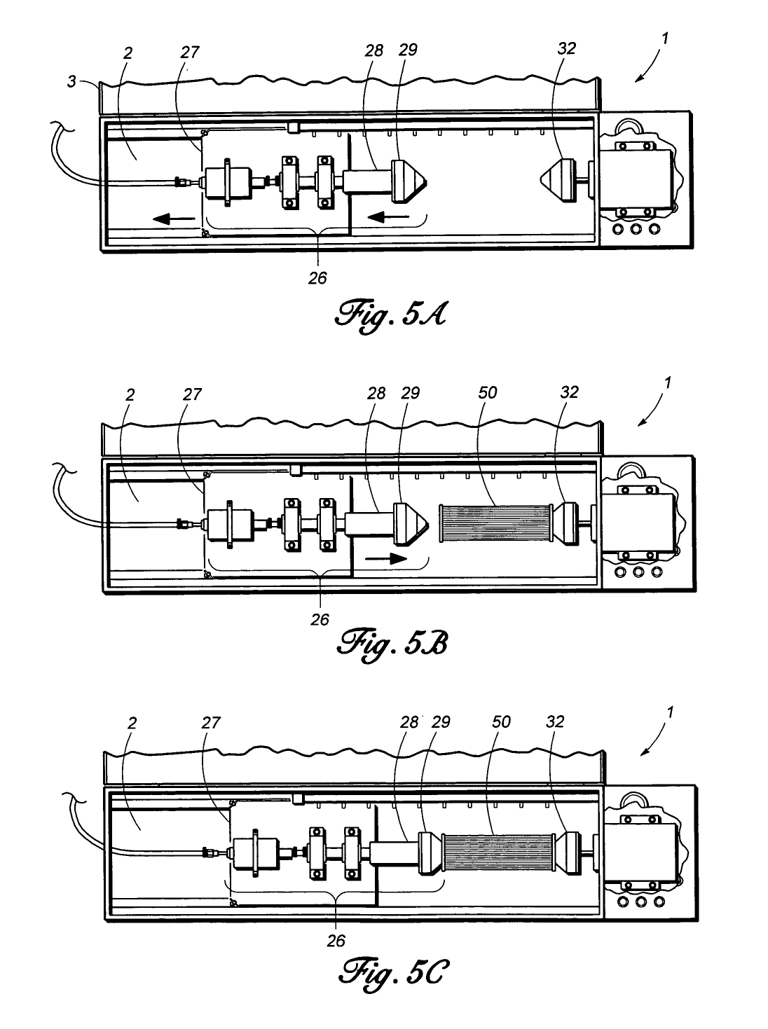

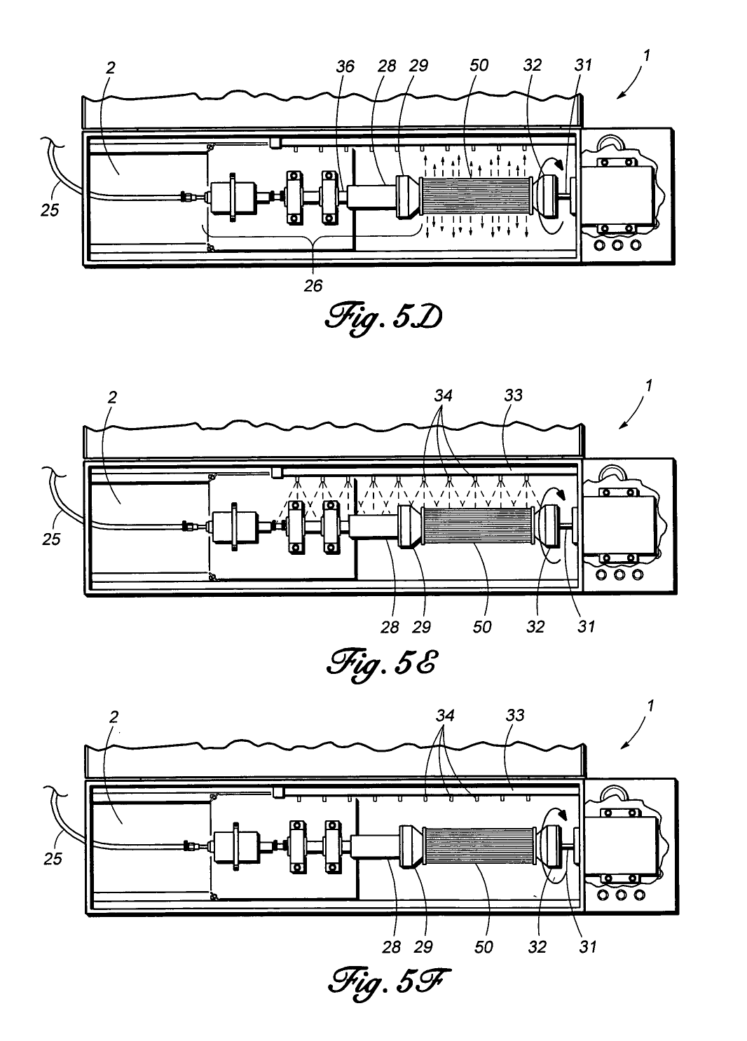

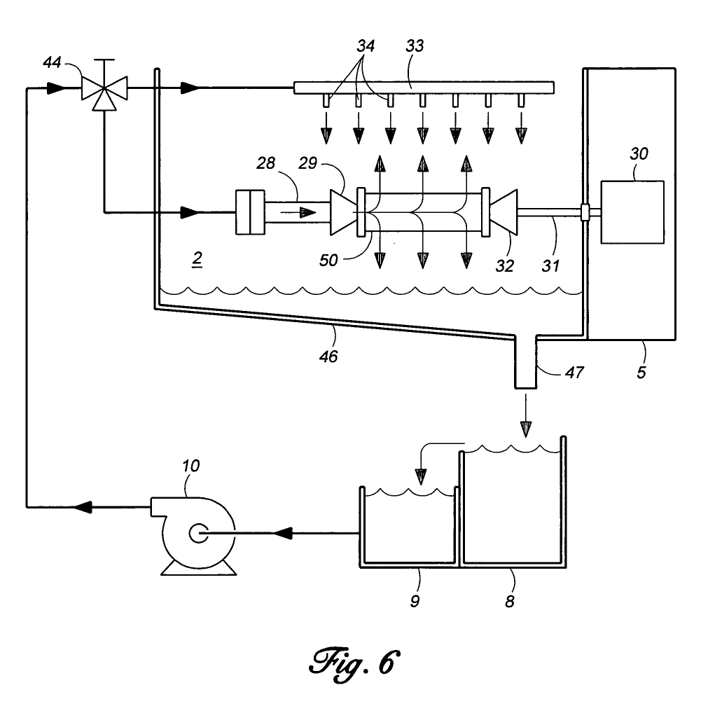

FIGS. 5A through 5F show the steps taken when the cartridge-filter cleaning machine 1 is used to clean a cartridge filter 50.

In FIG. 5A, the lid 3 of the cartridge-filter cleaning machine 1 has been opened, showing the cleaning chamber 2. In order to accommodate the length of the cartridge filter 50 being cleaned, the plate 27, upon which the components of the tail stock assembly 26 are mounted, is moved away from the drive motor cone 32. In order to further increase the distance between the cones 29, 32, the spring-loaded water inlet cone 29 can be pushed back, compressing the spring 35 inside shaft 28, shown in FIG. 3, supra.

As shown in FIG. 5B, a dirty cartridge filter 50 has been positioned with its right end against the drive motor cone 32. The plate 27 with the tail stock assembly 26 is slid in the direction of the cartridge filter 50 until the water inlet cone 29 rests against the left end of the cartridge filter 50.

FIG. 5C shows the dirty cartridge filter 50 firmly seated between the water inlet cone 29 and the drive motor cone 32. The spring tension of the spring 35 in the shaft 28 of the water inlet cone 29 helps hold the cartridge filter 50 in place. In addition, spring-loaded locking pins (not shown) located on the tail stock assembly 26 ensure that the cartridge filter 50 is held firmly in place during the spinning/cleaning process.

FIG. 5D highlights the first stage of cleaning. Heated water is injected from the flexible water supply line 25 through the hollow components of the tail stock assembly 26, the hollow shaft 36, and the hollow shaft 28 of the water inlet cone 29, and into the perforated tube of the cartridge filter 50. The power-driven motor 30 is activated, causing the shaft 31 on which the drive motor cone 32 is mounted to spin. When the cartridge filter 50 is properly installed, the drive motor cone 32 and shaft 31 will spin mechanically at a rate of approximately 550 revolutions per minute (RPM), plus or minus 5% (a range of 522.5 to 577.5 RPM's; any faster spinning could cause catastrophic damage to the cartridge filter 50). The centrifugal force created by the spinning motion displaces the heated water from the tube of the cartridge filter 50; the outward movement of the water through the perforations in the tube carries away dirt, debris, and oils which have collected on the filtering surface of the dirty cartridge filter 50.

As shown in FIG. 5E, as the drive motor cone 32 continues to rotate, the water from the finishing rinse supply pipe 33 is forced out through spray nozzles 34. The force of the water helps remove debris and dirt on the surface of the cartridge filter 50.

FIG. 5F illustrates the final step of the cleaning process, the “spin dry” cycle. The supply of water to both the flexible water supply line 25 and the finishing rinse supply pipe 33 is turned off, stopping the flow of water through the water inlet cone 29 and to the spray nozzles 34. The drive motor cone 31 continues to spin, with the centrifugal force removing excess water and debris from the now-clean cartridge filter 50.

The block diagram in FIG. 6 shows the flow of the heated water through the system. Primary reservoir 8 is filled with water, which flows to secondary reservoir 9, where it is suctioned into water pump 10, which pumps the water through the water isolation valve 44, through the hollow core of the shaft 28, through the hollow shaft of the water inlet cone 29, into the perforated tube of the cartridge filter 50. The power-driven motor 30, located in the control panel console 5, spins shaft 31 with drive motor cone 32, creating centrifugal force which causes the water to travel out through the filtering material of the cartridge filter 50. Water is also directed to finishing rinse supply pipe 33, where it is forced out through spray nozzles 34, causing it to “rinse” the surface of the cartridge filter 50. The water then drops to the slightly-sloped bottom 46 of the cleaning chamber 2, after which it is funneled through the water return pipe 47 back to the primary reservoir 8. The water is then reheated and recirculated through the system.

Although the foregoing describes an embodiment of the present invention with great specificity, it should be understood that the present invention encompasses other embodiments as well. For instance, the cartridge-filter cleaning machine may be a portable or mobile unit, with its power supplied by a generator. Further, the machine may be engineered to have several assemblies, each capable of holding, spinning, and cleaning a cartridge filter, so that several cartridge filters may be cleaned at one time.

We claim:

1. A machine using heated water and centrifugal force to clean a cylindrical cartridge filter having a first end and a second end and a perforated tube, the machine comprising:
an adjustable tail stock assembly having a rotatable hollow shaft having a first and a second end, the first end being attached to a water supply line and the second end having a first cone with a tip pointed away from the tail stock assembly, the shaft and first cone having hollow cores;
a power-driven motor controlling the rotational movement of a shaft holding a second cone having a tip pointing toward the tip of the first cone;
means for draining water used in cleaning the cartridge filter;
at least one reservoir for accepting water used in cleaning the cartridge filter;
means for heating water in the at least one reservoir;
a water pump connected to the water supply line;
means for supplying water to the machine;
means for supplying power to the machine;
a control panel for controlling the power-driven motor, the means for heating water, and the water pump;
wherein the first end of the cartridge filter is placed adjacent to the tip of the first cone and the second end of the cartridge filter is placed adjacent to the tip of the second cone, the cartridge filter then being held firmly in place between the first cone and the second cone, and wherein the water from the water supply line can travel through the shaft of the tail stock assembly, through the first cone, and into the perforated tube of the cartridge filter.

2. The machine in claim 1 which further comprises a length of water supply pipe with spaced-apart spray nozzles, the length of pipe being disposed parallel to the tail stock assembly and the cartridge filter held between the first cone and the second cone, the length of pipe receiving water for spraying onto the cartridge filter.

3. The machine in claim 1 wherein the first cone is disposed on a hollow shaft which holds a spring, the hollow shaft having an inner diameter sized to fit over the shaft of the tail stock assembly, the spring being compressed against an end of the shaft of the tail stock assembly.

4. The machine of claim 1 which further comprises a mesh screen for placement over the at least one reservoir to trap dirt and debris carried in water used in cleaning the cartridge filter.

5. The machine of claim 1 wherein the tail stock assembly and the first cone and the second cone are enclosed in a cleaning chamber having a lid for access.

6. The machine of claim 1 wherein the means for supplying power to the machine is selected from the group consisting of using electricity and using combustible fuel.
